(19) United States
(12) Patent Application Publication
(10) Pub. No.: US 2004/0206468 A1
(43) Pub. Date: Oct. 21, 2004

(54) Tear-off device for continuous materials

(75) Inventors: Wilfried Kolbe, Gulzow (DE); Andreas Kuckelmann, Ibbenburen (DE); Reinhold Hindemith, Ottersweier (DE); Wolfgang Brusdeilins, Bielefeld (DE)

Correspondence Address: RICHARD M. GOLDBERG, 25 EAST SALEM SREEET, SUITE 419, HACKENSACK, NJ, 07601, US

(73) Assignee: Maschinenbau Wilhelm Kochsiek GmbH, Leopoldshohe (DE)

(21) Appl. No.: 10/820,350

(22) Filed: Apr. 8, 2004

(30) Foreign Application Priority Data
Apr. 16, 2003 (EP) 03 008 665.6

(51) Int. Cl. F26B 3/00

(52) U.S. Cl. 162/286

(57) ABSTRACT

Tear-off device for sections (46) of a continuous material (18) with a pullout mechanism (10) for the transport of the continuous material (18) and with a tear-off mechanism (12), which has at least two pressure-applying elements (24, 26, 70), which are disposed on two opposite sides of the continuous material (18) and of which at least one can be positioned against the continuous material (18) by means of a positioning device, with the positioning device having at least one motor (42; 49; 60) and a control device (43) for the temporal control of the motor (42; 49; 60), with which the pressure-applying elements (24; 26; 70) can be positioned at a controllable point in time.

The invention relates to a tear-off device for sections of a continuous material, with a pullout mechanism and a tearing-off mechanism of the introductory portion of claim 1.

Such tear-off devices are used, for example, in tube machines as part of a bag line, in order to sever a continuous tube at perforated sites into tube sections. The continuous tube usually is transported by a pullout mechanism between mutually opposite, endless conveyor belts and supplied to the tear-off mechanism.

The German patent 44 40 660 discloses a tear-off device for tube sections. On both sides of the continuous tube, the tear-off mechanism of this device has mutually opposite pressure-applying rollers, each of which is mounted on pivoted arms, which are mounted on pivoted axes. The latter are opposite to one another on either side of the continuous tube, so that in each case the free end of the pivoted arm on one side of the continuous tube is adjacent to the pivoted axis of the pivoted arm on the second side of the continuous tube.

The conveyor belts of the tear-off mechanism initially do not engage the continuous tube. With the pivoting of the pivoted arms, the mutually opposite pressure-applying rollers are then engaged against the conveyor belts and the continuous tube between these belts. Since the speed of the conveyor belts of the tear-off mechanism is higher than that of the conveyor belts of the pullout mechanism, a tube section of the continuous tube is torn off at a prepared, perforated site. The pivoted arms are each pivoted by means of a ram bar or a tie bar, which is mounted like a connecting rod at a lever. The movement of the lever is controlled over a compression spring and a cam disk, which rotates in one direction and brings about tear-off processes periodically.

The EP 0 227 896 discloses a different tear-off device for tube sections, for which three pressure-applying rollers are firmly mounted in the tear-off mechanism on one side of the conveyor belts, while, on the other side of the conveyor belts, three pressure-applying rollers are mounted so that they can be shifted with the help of an eccentric disk against the other pressure-applying rollers.

The DE 41 13 792 discloses a tear-off device, which differs from the aforementioned ones, particularly owing to the fact the pressure-applying rollers are mounted displaceably on both sides of the conveyor belts and can be moved synchronously with a coupling linkage.

It is an object of the invention to provide a tear-off device of the type named above, which permits a variable and temporally accurate control of the tear-off process.

Starting out from a tear-off device of the introductory portion of claim 1 for which at least one pressure-applying element can be adjusted by means of a positioning device, this objective is accomplished pursuant to the invention owing to the fact that the positioning device has at least one motor and a control device for the temporal control of the motor, with which the pressure-applying element can be engaged at a controllable point in time.

The preceding is based on the idea that the timing of engaging of the pressure-applying element is controlled by the motor and not fixed by an eccentric disk or a different, rigid mechanism. The movement of, for example, a servomotor can be controlled temporally and accurately with a known control device.

This has the advantage that the engaging process can be adapted to different operating conditions and continuous materials, such as continuous tubes with different tube formats, especially different lengths of the tube sections. Accordingly, it is not necessary to modify the tear-off device when the format of the section is changed.

Preferred embodiments of the invention arise out of the dependent claims.

The control device preferably is a programmable control device, with which the point in time of the engagement movement and, depending on the embodiment, also the point in time of the withdrawal movement can be adjusted in relation to the transport of the continuous material.

In advantageous embodiments, the at least one pressure-applying element is engaged and withdrawn owing to the fact that the motor carries out only a small movement back and forth, which brings about the engaging and withdrawal movement of the pressure-applying element. Such a movement of the motor is either a rotational movement or, in the case of a linear motor, a translational movement. In this way, the operating parameters, such as the travel time during the engagement or withdrawal of the pressure-applying elements, can be adjusted individually. Aside from the points in time of the engaging and withdrawal movements, the traversing distance of the motor can also be programmed.

In other preferred embodiments, the motor carries out a rotational movement in one direction, for which the pressure-applying elements alternately are engaged and withdrawn, the speed of the motor preferably being variable and preferably being variable even up to the stoppage of the motor. Such a movement of the motor can also be controlled accurately and temporally with a known control device and has the advantage that smaller accelerations are required, since there is no reversing operation of the motor. Preferably, pressure-applying elements are mounted in this case on one or both sides of the continuous material so that, together with their mounting, they can be shifted by means of at least one second motor against the continuous material and the oppositely located pressure-applying elements. By varying the traversing distance of the second motor, the pressure applied can be varied in this way.

The two variations mentioned of the movement of the motor have the advantage that their parameters can be adapted to different operating conditions and continuous materials, such as continuous tubes with different tube formats, different types of continuous materials, such as different types of paper, and different machine speeds. The duration as well as the strength of the pressure-applying process can be adapted in a very simple way to different types of continuous materials, which may have, for example, different coefficients of friction or for which different forces are required for severing the perforation. Moreover, the exact adjustment of the operating parameters for the tear-off process permits the use of machine speeds, which are higher than those possible with conventional tear-off devices, for which the course of the tearing-off process is rigidly fixed.

It is furthermore advantageous that servomotors and linear motors have a high torque or a high power even at very low speeds or when stopped and can have high dynamics, an accurate control of position being attainable by a control circuit with a positioning sensor. If the elastic properties of the pressure-applying elements, of the continuous material, and of any conveyor belts are known, the pressure-applying power of the engaged pressure-applying element can be determined, depending on the embodiment, by varying the distance traversed by the motor or by the position of the second motor.

Instead of a servomotor or a linear driving mechanism, a different direct driving mechanism or a stepper motor can be provided equally well.

The advantageous adaptability of the operating parameters of the inventive tear-off device can be increased in a preferred manner owing to the fact that the pullout mechanism and the tear-off mechanism each have their own driving mechanism. This enables the transporting speed to be adapted individually to different types of continuous materials. In particular, the transporting speed of the tear-off mechanism, which exceeds that of the pullout mechanism, can be adapted to that required for the tearing-off process, depending on the type of continuous material. In conjunction with the variable residence time of the pressure-applying element in the engaged state, it is furthermore possible to adapt the tearing-off process to the length of the section of continuous material as well as to the transporting speed of a subsequent processing device.

In a first embodiment of the invention, the pressure-applying elements, disposed on both sides of the continuous material, are mounted in each case in pivoted arms, which are connected over at least one tie bar or ram bar with the positioning device. The motor of the positioning device brings about a pulling or compressing movement of the tie bar or ram bar, as a result of which the pivoted arms are pivoted relative to one another.

The tie bar and/or ram bar can be connected, for example, in the form of a connecting rod with at least one motor driven shaft, due to the rotation of which they can be pivoted synchronously. The engagement and withdrawal of the pressure-applying elements can be accomplished by a back and forth movement of the motor or the connecting rod-like connection can be constructed so that the motor can have a fixed direction of rotation. Alternatively, the motors of the positioning device are linear motors, which act as driving mechanisms for the tie bar and/or the ram bar. Preferably, the pivoted arms are connected with a coupling linkage so that they can be pivoted synchronously.

In the case of a second embodiment, the positionable pressure-applying elements are pressure-applying rollers, each of which is mounted rotatively on an eccentric and the eccentrics can be rotated individually or jointly by the at lease one motor of the positioning device. At least one pressure-applying roller, located on a first side of the continuous material, can be engaged. By means of a rotational movement, the pressure-applying roller, mounted on the eccentric, can be engaged against or withdrawn away from the oppositely located pressure-applying roller and the continuous material between the two rollers. Alternatively, the two oppositely located pressure-applying rollers can also be moved towards one another.

Depending on the distance between two oppositely located pressure-applying elements, the rotational movement of the eccentric can take place back and forth over a limited traversing distance or continuously in one direction at a variable speed. In this case, the pressure-applying element preferably together with its mounting can be shifted by means of the at least one second motor against the continuous material and the oppositely located pressure-applying element, so that the pressure applied can be varied.

The latter distinguishing feature is preferably present also in a third embodiment, for which the engageable pressure-applying element in each case has roller segments, which are mounted rotatably and can be rotated individually or jointly by the motors or the motor of the positioning device. For the third embodiment, the pressure-applying elements are rotated at the start of the tearing-off process, so that the roller segments are turned towards the continuous material or the conveyor belts, so that they engage the continuous material. The timings of the engagement of the roller segments preferably can be adjusted with the programmable control device of the motor in relation to the transport of the continuous material. While the roller segments are engaged, they can continue to be driven, or run freely with any conveyor belts.

In the following, preferred examples of the invention are described in great detail by means of the drawing, in which

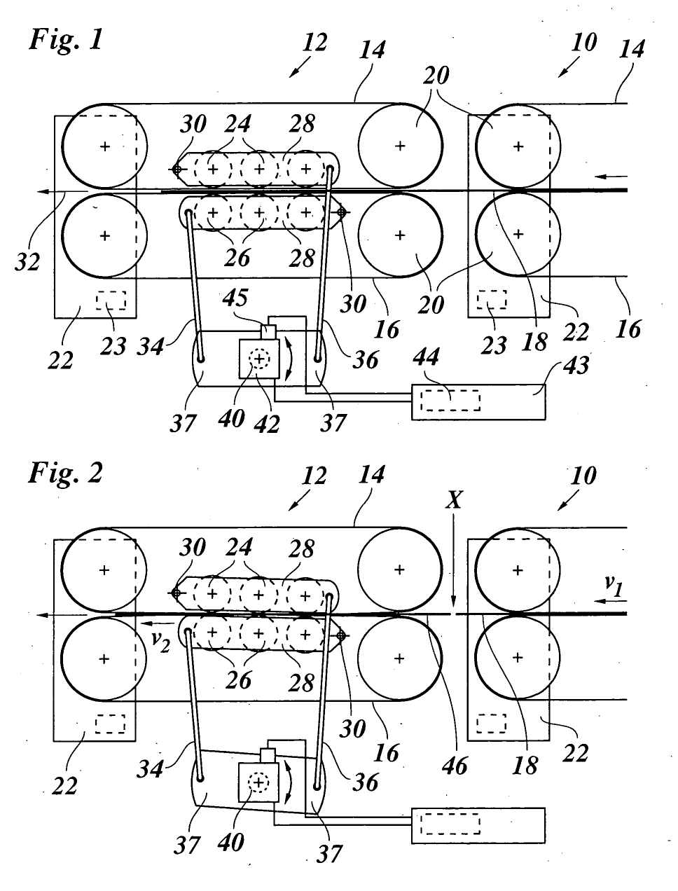

FIG. 1 shows a diagrammatic side view of a first embodiment of the tear-off device with pivoted arms,

FIG. 2 shows the tear-off device of FIG. 1 with the engaged pressure-applying rollers,

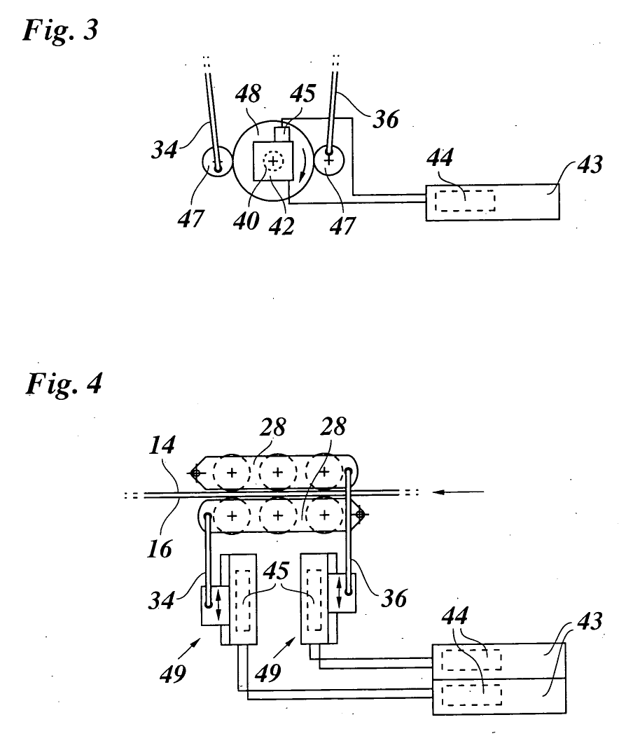

FIG. 3 shows a partial view of a variation of the first embodiment of FIG. 1 with a rotationally drivable motor,

FIG. 4 shows a diagrammatic side view of the first embodiment with linear motors,

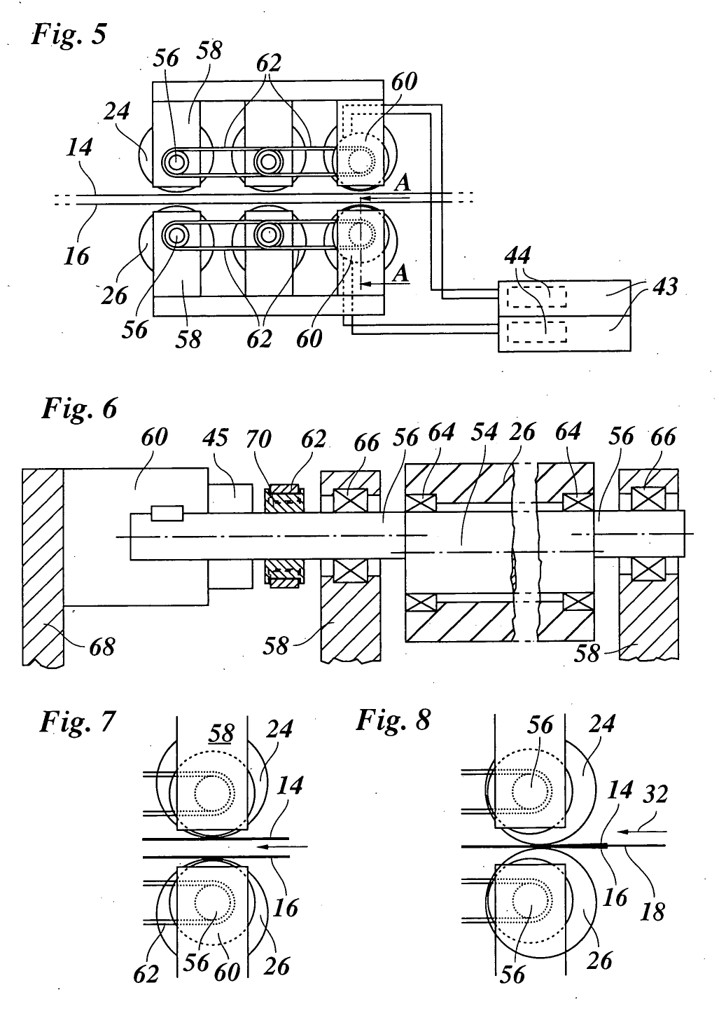

FIG. 5 shows a diagrammatic side view of a second embodiment with eccentrically movable pressure-applying rollers,

FIG. 6 shows a longitudinal section through a pressure-applying roller of FIG. 5 together with the mounting and the motor,

FIG. 7 shows a detailed view of two pressure-applying rollers of FIG. 5 in the withdrawn position,

FIG. 8 shows the pressure-applying rollers of FIG. 7 in the engaged position and

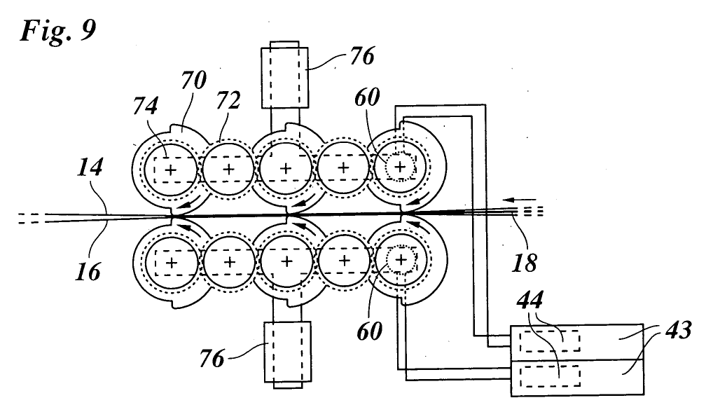

FIG. 9 shows a diagrammatic side view of a third embodiment with roller segments.

FIG. 1 shows a tear-off device with a pullout mechanism 10 and a tear-off mechanism 12. The pullout mechanism 10 and the tear-off mechanism 12 each have upper endless conveyor belts 14 and lower endless conveyor belts 16. A continuous material 18 is transported between the conveyor belts 14 and 16. The conveyor belts 14 and 16 run on idler pulleys 20 and are driven by driving mechanisms 22, which are controlled by control devices 23. On the upper side of the continuous material 18, the tear-off mechanism 12 has three upper pressure-applying rollers 24, which are opposite to three lower pressure-applying rollers 26 on the underside of the continuous material 18.

The pressure-applying rollers 24 and 26 are mounted in each case in pivoted arms 28, each of which is mounted at a pivot axis 30. The continuous material 18 is moved in a first transporting direction 32, which is indicated by an arrow, between the conveyor belts 14 and 16 of the tear-off mechanism, which is in contact with the pressure-applying rollers 24 and 26. At the same time, in the position of the pressure-applying rollers 24 and 26, shown in FIG. 1, the conveyor belts 14 and 16 of the tear-off mechanism 12 do not engage the continuous material 18, so that the transporting speed of the continuous material 18 is determined by the conveyor belts 14 and 16 of the pullout mechanism 10.

The pivoted arms 28 are located opposite to one another on either side of the continuous material 18, so that the free end of the pivoted arm 28 on a first side of the continuous material 18 is adjacent to the pivot axis 30 of the pivoted arm 28 on the second side of the continuous material 18. The pivoted arms 28 thus are pivotable at opposite ends. A ram bar 34 is hinged at the end of the lower pivoted arm 28, opposite to its pivot axis 30, whereas a tie bar 36 is hinged at the upper pivoted arm 28. The tie bar 36 and the ram bar 34 are mounted like connecting rods at mutually opposite side arms 37 of a rotatably mounted shaft 40 of a servomotor 42, so that the pivoted arms 28 can be pivoted by means of a rotational movement of the shaft 40 and of the side arms 37, brought about by servomotor 42.

The position of the servomotor 42 can be controlled selectively and temporally with an electronic control device 43. The control device 43 may, for example, be a memory-programmable control device. The control electronics 44 of a control circuit of the servomotor 42 are integrated in the control device 43. The control circuit has a position sensor 45, which is disposed at the servomotor 42 and integrated there and recognizes the position of the servomotor 42. The traversing distance and the timing control of the servomotor 42 can be programmed by the control device 43. On the other hand, the control electronics 44 control the instantaneous, nominal position of the servomotor 42 by means of the position sensor 45. The control device 43 and the control devices 23 of the driving mechanism, which may appropriately have control circuits with position sensors, interact during the operational control of the tear-off device. For example, the points in time of the engagement and withdrawal motions in relation to the transport of the continuous sheet 18 can be adjusted with the control device 43.

FIG. 2 shows the tear-off device of FIG. 1, for which the pressure-applying rollers 24 and 26 are positioned against one another. For this purpose, both pivoted arms 28 are pivoted about their pivot axis 30. As can be seen in FIG. 2, a smaller rotational movement of the shaft 40 with the side arms 37 is sufficient in order to pivot the pivoted arms 28 by means of the ram bar 34 and the tie bar 36, so that the pressure-applying rollers 24 and 26 are engaged. Because the speed of the conveyor belts 14 and 16 of the tear-off mechanism 12 is greater than that of the pullout mechanism 10, the continuous sheet 18, taken hold of by the conveyor belts 14 and 16 of the tear-off mechanism 12 between the pressure-applying rollers 24 and 26, is severed at a perforated site marked with an arrow X, and a section 46 of material is severed. Because the transporting speed v₂ of the tear-off mechanism 12 is higher than that v₁ of the pullout mechanism 10, the severed section 46 of material is removed during the further transport from the rest of the continuous material 18. The transporting speeds v₁ and v₂ can be specified independently of one another by way of the driving mechanism 22, as required.

FIG. 3 shows a section of a modified embodiment of the tear-off device of FIG. 1, for which the tie bar 36 and the ram bar 34 in each case are mounted like a connecting rod at the wheels 47, which are coupled with a wheel 48. The wheel 48 can be driven by a motor 40. In contrast to the example shown in FIGS. 1 and 2, the travel of the tie and ram bars, so constructed and mounted like connecting rods, is such here that an engaged and a withdrawal of the pressure-applying rollers 24 and 26 is accomplished alternatively by means of the motor 40 revolving in one direction. It is particularly advantageous that, as a result, lower accelerations are required, because a reverse operation of the motor is avoided. In this connection, the control device 43 can accelerate or even stop the motor 40, so that the pressure-applying rollers 24 and 26 can remain for a variable period of time in the engaged state.

The example, shown in FIG. 3, can also be modified in that only one tie bar 36 or ram bar 34 is mounted like a connecting rod at a driven wheel 47 and the pivoted arms 28 are connected with a coupling linkage, so that they can be pivoted synchronously.

In FIGS. 4 to 9 of the embodiment, described in the following, only a portion of the tear-off mechanism 12 is shown in each case. The driving mechanisms of the conveyor belts 14 and 16 and of the pullout mechanism 10 correspond to those of the first embodiment.

FIG. 4 shows a modified embodiment of the tear-off device of FIG. 1, for which the ram bar 34 and the tie bar 36 in each case are mounted at a linear motor 49, so that the pivoted arms 28 can be pivoted by means of a pulling or pushing movement, which is brought about by linear motors 49. By these means, a very short travel time can be achieved during the engagement or withdrawal of the pivoted arms 28. The positions of the linear motors 49, in turn, can be controlled selectively and temporally by known means with control devices 43 and have control electronics 44 and position sensors 45.

FIG. 5 shows a second embodiment. The upper pressure-applying rollers 24 and the lower pressure-applying rollers 26 are mounted rotatably here on roll axes 54 (FIG. 6), which are mounted in bearing plates 58 over eccentrically positioned driving mechanism axes 56. The pressure-applying rollers 24 and 26 can be pivoted about the respective driving mechanisms axis 56 by means of a rotational movement of the corresponding driving axes 56. The driving axes 56 are driven by servomotors 60. The driving axes 56 of the upper pressure-applying rollers 24 and the lower pressure-applying rollers 26 are power-coupled over cogged belts 62 and are driven by a servomotor 60. Instead of with cogged belts 62, the power-coupling of the pressure-applying rollers 24 and 26 can also be accomplished, for example, over gear wheels.

In the position of the pressure-applying rollers 24 and 26, shown in FIG. 5, the upper conveyor belt 14 and the lower conveyor belt 16 of the tear-off mechanism 12 do not engage one another.

Similarly to the embodiments already described, the control devices 43 of the servomotors 60 are provided with control electronics 44 and position sensors 45 (FIG. 6), which recognize the positions of the servomotors 60.

FIG. 6 shows a cross section through a lower pressure-applying roller 26 and the associated servomotor 60 of FIG. 5, corresponding to the plane A marked in FIG. 5. The pressure-applying roller 26 is mounted rotatably with fitted bearings 64 on the roll axis 54. At the ends of the roll axis 54, a part of the driving axis 56 is fastened eccentrically. Alternatively, the roll axis 54 and the drive axis 56 can also be produced in one piece. The drive axis 56 is mounted in the bearing plates 58, so that it can be rotated in bearings 66. The servomotor 60, which is held at a plate 68, which is not shown in FIG. 5, drives the drive axis 56. The position sensor 45 is disposed at the servomotor 60.

By means of a rotational movement of the drive axis 56, the roll axis 54 is pivoted about the drive axis 56. The lower pressure-applying roller 26, mounted rotatably on the roll axis 54, can be positioned against the opposite upper pressure-applying roller 24.

On the drive axis 56, a gear wheel 70 is fastened and engaged by the cogged belt 62, with which the power of the servomotor 60 is transferred to the other drive axes 56 of the lower pressure-applying rollers 26. The arrangement of the elements described at the roll axes 54 and the drive axes 56 represents only an example.

FIG. 7 shows a section of FIG. 5 with the two pressure-applying rollers 24 and 26 at the right. The drive axes 56, the servomotors 60, the cogged belts 62 and the bearing plates 58 are shown. While the drive axes 56 are stationary, the pressure-applying rollers 24 and 26 are carried along by the conveyor belts 14 and 16 and rotate about their roll axes 54 (FIG. 6). The distance between a pressure-applying roller 24 or 26 and the conveyor belt 14 or 16, passing by the pressure-applying roller 24 or 26, may, however, also be so large, that the pressure-applying roller is not carried along.

FIG. 8 shows the same view as FIG. 7. However, the pressure-applying rollers 24 and 26 are positioned against the conveyor belts 14 and 16. For this purpose, the pressure-applying rollers 24 and 26 were pivoted counter to the continuous material 18 by way of drive axes 56 of the transporting device 32 rotating in opposite directions. In FIG. 8, the distance between the drive axes 56 is so small, so that the pressure-applying rollers 24 and 26 collide with one another even before their maximum vertical deflection, so that the drive axes 56 are unable to carry out a complete revolution. The withdrawal of a pressure-applying roller 24 or 26 is therefore accomplished by reversing the direction of rotation of the motor 60.

However, if the distance between the drive axes 56 is so large, that the pressure-applying rollers 24 and 26 collide with one another only at their maximum vertical deflection, it is also possible to operate the motor 60 with a fixed direction of rotation. On the one hand, an extremely short duration of the tearing-off process can be achieved, in that the motor 60 is not stopped. This may be of advantage, for example, in the case of brittle paper. On the other hand, a longer period between the positioning and parking of the pressure-applying rollers can be achieved if the drive axes 56 remain in the position in which the pressure-applying rollers 24 and 26 are engaged.

Alternatively, to the example described, it is also possible to have an embodiment, in which only the pressure-applying rollers on one side of the continuous sheet 18 can be placed against the opposite pressure-applying rollers, which have stationary roll axes 54.

If the pressure-applying rollers on both sides of the continuous material can be engaged, it is also possible to have all drive axes 56 coupled by cogged belts or gear wheels and to have them driven by a single servo motor 60.

In every case, only a rotational movement of the servomotor 60 is required for engaging a pressure-applying roller in the case of the second embodiment. Such a movement can be carried out very quickly, so that the time taken for engaging or withdrawing the pressure-applying rollers for severing a section of material 46 from the continuous material 18 can be adjusted selectively by means of the control device 43.

FIG. 9 shows a third embodiment with pressure-applying elements 70 and roller segments, which can be positioned, being coupled on both sides of the continuous sheet 18 over gear wheels 72 and mounted rotatably at a frame 74. The pressure-applying elements 70 are driven by the motors 60 in a direction of rotation, indicated by an arrow. FIG. 9 shows the instant at which the roller segments of the pressure-applying elements 70 are positioned against one another and brought into an engagement with the conveyor belts 14 and 16 as well as with the continuous material 18. In the positioned state, they continue to rotate and transport the severed section of the continuous material 18 and can be driven further or carried along freely with the conveyor belts 14 and 16. In the example shown, the engaged state of the pressure-applying elements 70 ends after one rotation of about 180°. The time of the next engaging process can be controlled by means of the control devices 43 of the motors 60.

The frame 74 can be shifted vertically by means of second motors 76. The contacting pressure of the positioned pressure-applying elements 70 can be varied in this way and adapted to different thicknesses of the continuous material.

Such a displaceable mounting of the pressure-applying elements 70 can also be used advantageously for the example shown in FIG. 5.

Alternatively to the example shown in FIG. 9, it is also possible that only the pressure-applying elements 70 on one side of the continuous material 18 have positionable roll segments or are mounted on a displaceable frame.

For all the embodiments of the invention that have been described, the control devices 43 of the motors 42, 60 or 49 permit a programmable adaptability of the operating parameters, such as the traversing distance of the motors or the times of the engagement or withdrawal movements in relation to the transport of the continuous material 18. In conjunction with independent driving mechanisms 22 for the pullout mechanism 10 and the tear-off mechanism 12, with the drive-control devices 23 of which the control devices 43 can interact, the inventive tear-off device can be adapted particularly well to different parameters of the continuous sheet 18, which is to be processed. Different formats of the sections of the continuous sheet, continuous sheets of different thicknesses, different types of paper or other types of material of the continuous material as well as different transporting rates are examples of this. Furthermore, for special purposes, it is also conceivable that the pullout mechanism and/or the tear-off mechanism in each case have their own driving mechanism for the conveyor belts on a first side and on a second side of the continuous sheet.

In the examples shown, the axes of pressure-applying elements, opposite to one another on either side of the continuous material, are disposed vertically to one another. However, the invention also comprises arrangements, for which the pressure-applying elements are disposed relatively offset to one another in the transporting direction on either side of the continuous material, so that, when the pressure-applying elements are positioned, the continuous material passes in corrugated form through the tear-off mechanism.

Although the examples described in all cases have conveyor belts 14 and 16, it is also possible to do without these and to transport the continuous material 18 in some other way.

What is claimed is:

1. Tear-off device for sections of a continuous material, comprising:
a pullout mechanism for the transport of the continuous material and
a tear-off mechanism, which has at least two pressure-applying elements, which are disposed on two opposite sides of the continuous material and of which at least one can be engaged against the continuous material by a positioning device, the positioning device having at least one motor and a control device for temporal control of the at least one motor, with which the pressure-applying elements can be engaged at a controllable point in time.

2. The tear-off device of claim 1, wherein the motor is a servomotor.

3. The tear-off device of claim 1, wherein the pullout mechanism and the tear-off mechanism each have their own driving mechanism.

4. The tear-off device of claim 1, wherein the control device is a programmable control device, with which the points in time of the engaging and/or withdrawal movements can be adjusted in relation to the transport of the continuous material.

5. The tear-off device of claim 1, wherein the pressure-applying elements, disposed on either side of the continuous material, each are mounted in pivoted arms, which are connected over at least one of a tie bar and ram bar with the positioning device.

6. The tear-off device of claim 5, further comprising a coupling linkage which connects the pivoted arms on either side of the continuous material, so that they can be pivoted synchronously.

7. The tear-off device of claim 5, wherein the positioning device has at least one shaft, which is driven by the at least one motor and by which the at least one of the tie bar and ram bar can be driven in the form of a connecting rod.

8. The tear-off device of claim 1, wherein the adjustable pressure-applying elements are pressure-applying rollers, which are mounted in each case rotatably on an eccentric and the eccentrics can be driven one of individually and jointly by the at least one motor of the positioning device.

9. The tear-off device of claim 8, wherein at least one of the pressure-applying elements is mounted so that it can be shifted by at least one second motor essentially perpendicularly to the continuous material.

10. The tear-off device of claim 1, wherein the adjustable pressure-applying elements (70) in each case have roll segments, which are mounted rotatably and can be driven one of individually and jointly by the at least one motor of the positioning device.

11. The tear-off device of claim 10, wherein at least one of the pressure-applying elements is mounted so that it can be shifted by at least one second motor essentially perpendicularly to the continuous material.

12. The tear-off device of claim 1, wherein the at least one motor of the positioning device can be driven over a limited traversing distance in opposite directions and adjusting movements of the at least one motor can be controlled with respect to time by the control device.

13. The tear-off device of claim 1, wherein the traversing distance of the at least one motor is programmable.

14. The tear-off device of claim 1, wherein the at least one motor is a linear motor.

15. The tear-off device of claim 1, wherein the at least one motor can be driven to rotate with a variable speed in one direction of rotation.

16. The tear-off device of claim 15, wherein the speed of the at least one motor can be varied down to zero.
